(19) United States
(12) Patent Application Publication
(10) Pub. No.: US 2014/0289147 A1
(43) Pub. Date: Sep. 25, 2014

(54) SYSTEM AND METHOD FOR CALCULATING EMPLOYEE ELIGIBILITY OF HEALTH CARE BENEFITS

(71) Applicants: Alicia Jordan HAFF, San Antonio, TX (US); Lee MANROSS, Austin, TX (US); Heather Cawyer GARCIA, San Antonio, TX (US)

(72) Inventors: Alicia Jordan HAFF, San Antonio, TX (US); Lee MANROSS, Austin, TX (US); Heather Cawyer GARCIA, San Antonio, TX (US)

(21) Appl. No.: 13/848,410

(22) Filed: Mar. 21, 2013

(51) Int. Cl. G06Q 10/10

(52) U.S. Cl. CPC G06Q 10/1057
USPC 705/322

(57) ABSTRACT

A system and method for assisting companies and employers in complying with various laws, rules and regulations regarding employee health care benefits and insurance plans, specifically including the Affordable Care Act. In one embodiment, web-based software is programmed to receive data from an employer on a regular basis, and then uses the data to make certain determinations regarding employee eligibility for health care benefits, to provide alerts to employers, and to generate reports. The software is programmed to notify the employer regarding crucial deadlines, changes in status of employees that may trigger health care plan eligibility, and alert the employer when steps must be taken for the employer to maintain compliance with such laws, rules and regulations.

### BACKGROUND OF THE INVENTION

With the recent enactment of the Affordable Care Act (ACA), Congress has set forth laws and rules to govern the relationship between employers and employees with respect to health insurance plans. The present invention relates to a system and method for assisting all employers, both public and private entities, in tracking their workforce in order to comply with the ACA regulations, timelines and other rules, in order to minimize or avoid regulatory penalties (hereinafter “System”).

Starting in 2014, Applicable Large Employers (“ALEs”) must offer affordable minimum value (A/MV) healthcare to their employees or face penalties for failing to do so. So, in order to avoid these penalties, employers must do several things: 1) Determine if the employer is an ALE, 2) if an employer is properly classified as an ALE, then determine who in the workforce is eligible for coverage and when coverage should be offered, 3) determine whether employer is offering Full-Time employees “affordable coverage,” which means that the least expensive “base” plan of employee only coverage offered by employer must not exceed the maximum percentage (currently 9.5%) of the employee's taxable income contained in Box 1 of Employee's W-2, 4) determine whether the plan's share of the total allowed costs of benefits provided under the plan is at least 60% of such costs for the employee only coverage, and 5) determine whether the employer has any liabilities for annual penalties for non-compliance of laws, rules or regulations.

A step-by-step analysis of each above-listed determination is discussed in detail:
1. Determine if the Employer is an ALE. IRS has provided a formula to calculate this:

Full-Time employees (“FT”) (working average 30+ hrs a week)+(Total part-time hours worked in a month/120)=Total Full Time Equivalents (“FTEs”). If an employer's workforce is stagnant (no new hires, no terminations and no variable part-time hours worked), then the calculation simply requires plugging the raw data required for the formula once a year. For example, Employer has 42 FT employees and part-time hours worked in a month total 960.

FORMULA: 42+(960/120=8)=50 FTEs.

In this case, the employer is considered an ALE, and is subject to the requirement that healthcare coverage be offered or penalties be paid.

However, most employers do not have stagnant workforces. FT employees are hired and fired as needed. Part-Time employees work different number of hours in each month. So, the formula is more complicated. Now the employer must track the total number of FTEs each month and average these numbers at the end of the calendar year to determine if the employer is considered an ALE for the following calendar year. As well, some employers may not be ALEs for a full calendar year but if it employs at least 31 FT employees, and the employee workforce is not stagnant, these employers should continually run the formula to determine ALE status on a monthly basis to ensure it does not become an ALE and fail to offer benefits.
2. Employer has been classified as an ALE and now must determine who in the workforce is eligible for coverage and when coverage should be offered.

First, historically, Payroll Departments and Human Resource (“HR”) Departments struggle to communicate effectively and efficiently. So, Employee may be hired with a start date of Jan. 1, 2014 and is expected to be a Full-Time Employee. Assuming the HR Department calendars that eligibility and the opportunity to enroll in benefits is 90 days from start date, Payroll Department must alert HR Department if the employee's hours drop below 30 (so may not be eligible for benefits); must keep up with all days worked (for instance working over the weekend would move up the 90 days because those are now days worked); and must calculate that the employee's portion of health insurance premium of the base benefit plan is not more than 9.5% of the employee's taxable income.

Secondly, a different situation arises if an employee is hired as a Part-Time employee (expected to work less than 30 hours a week) and HR Department categorizes employee as PT and not eligible for benefits. Subsequently, the employee works more than 30 hours and is paid for the hours. Payroll Department tracks this for pay purposes, but Payroll Department fails to advise HR Department of the additional hours worked and so HR Department does not offer Employee benefits and opportunity to enroll by the 91^{st} day of full-time employment. In this situation, a simple lack of communication between the Payroll Department and HR may expose the employer to expensive penalties.

Thus, the employer must determine who are “Eligible Employees” and offer coverage and opportunity to enroll in a timely manner.

### Who are Eligible Employees?

a. All FT employees (working 30+ hours a week) are eligible and must be offered healthcare coverage and opportunity to enroll by the 91^{st} day of work.
b. Seasonal Employees if they work full time for more than 120 days in a calendar year thusly making these persons FT employees.
   Failure to offer coverage and enroll “Substantially All” Eligible Employees by 91st day of work could subject an employer to Section 54.4980H(a) Penalties (“Sledgehammer Penalties”). Annual penalty (calculated monthly) of $2000 for ALL ELIGIBLE EMPLOYEES regardless of whether these employees are offered or are enrolled in healthcare coverage. If the error is corrected during the calendar year, the employer is only subject to penalties for the months the employer was out of compliance.
Example: Employer has 100 FT Eligible Employees. 90 of these employees have been offered A/MV coverage within 90 days of employment start date. 10 FT Eligible Employees have not been offered the A/MV coverage and 1 of these employees seeks coverage and subsidies (tax credits) through the Exchange. Employer will be fined $2,000×100—first 30 FT EEs=$140,000.

Employer is not entitled to any notice from the Employee seeking coverage through the Exchange and may not be aware of its error or the penalties owed until the next calendar year when the IRS will send notice of penalties resulting from tax information. So, an employer who inadvertently failed to offer eligible employees coverage cannot “fix” the mistake and avoid penalties based on notices from the Employee or Government because there will be no notices provided during the applicable time period.
3. Currently, “Affordable Coverage” means the least expensive coverage offered by the employer cannot exceed 9.5% of the Employee's total taxable wages contained in Box 1 of Employee's W-2.
4. Currently, “Minimum Value” requirement dictates that the plan's share of the total allowed costs of benefits provided under the plan is at least 60% of such costs.
5. 4980H(b) Penalties: Employer does offer coverage to eligible employees but it is not classified as “affordable.”

If the employee's portion of cost for coverage exceeds 9.5% of employee's W-2 income, and the employee seeks coverage through the Exchange and receives subsidies (tax credits), the Employer will be penalized $3,000 per annum for every employee whose coverage is deemed not affordable and who seeks coverage through the Exchange and is entitled to subsidies/tax credits.

Thus, there currently exists a need for a system and method to assist employers in navigating the complicated and onerous rules and regulations set forth in the Affordable Care Act, as well as other legislation, which governs the relationship between employees and employers regarding health care insurance and related expenses, in order to offer coverage when obligated, reduce costs, streamline the compliance process, and avoid costly penalties imposed by the government.

### BRIEF SUMMARY OF THE INVENTION

In accordance with one aspect of the invention, a system and method is provided for assisting employers in tracking their workforce in order to comply with healthcare laws, rules and regulations, including the Affordable Care Act. The present system and method includes software that allows importation of pre-existing information, which is already tracked by the client, and the system then uses the raw data of that information to make calculations to determine 1) whether the company qualifies as an Applicable Large Employer (ALE), 2) which employees in the workforce are eligible for coverage and when coverage should be offered, 3) whether the company is complying with the requirement that Full-Time (FT) employees cost of coverage does not exceed the maximum allowance of the employees total taxable wages set forth on the Employee's W-2 form, and 4) whether the company has any liability for annual penalties for non-compliance of regulations. Perhaps, most important, the system identifies individuals who were owed but not offered/enrolled in coverage so that the company may correct the error and limit its liability.

Operationally, the system imports or receives raw data from the employer from current payroll information and/or employee time and attendance data on a regular basis for a specific time period, preferably through Excel or CSV files. Such data may include each employee's name, unique identifier, status of hourly or salary employee, number of hours worked in a week, and pay for these hours. Employees are then classified by the system (either automatically or manually) as FT salary employees, FT hourly employees, Part-Time employees, Seasonal employees, or employees missing from payroll. The system then confirms the classifications, identifies employees who are not receiving benefits but may be eligible and when and alerts employer, runs monthly checks to determine “affordability,” and tracks employees covered and those who have been offered coverage but have declined. The system is programmed to provide various alerts to the employer to facilitate compliance, and is also used to generate reports including valuable compliance information to the employer at regular intervals. In one embodiment, it is contemplated that the system may be used by a service provider on behalf of client companies, so that the client companies provide the raw data to the service provider, and the service provider runs the software, and provides the alerts and reports on a regular basis to the client company for a subscription or fee. It is further contemplated that the system may be web-based, so that the system is run through a website and maintained by a service provider, and is used via the internet by the client companies.

### BRIEF DESCRIPTION OF THE DRAWINGS

These and other features, aspects, and advantages of the present invention will become better understood with regard to the following description, appended claims, and accompanying drawings where:

FIG. 1 is a flow-chart representation of one aspect of the system and method for calculating employee eligibility of health care benefits.

### DETAILED DESCRIPTION OF THE INVENTION

The present invention includes a system and method for assisting companies and employers in complying with various laws, rules and regulations regarding employee health care benefits and insurance plans, specifically including the Affordable Care Act. In one embodiment, web-based software is programmed to receive data from an employer on a regular basis, and then uses the data to make certain determinations regarding employee eligibility for health care benefits, to provide alerts to employers, and to generate reports. Because much of the health care law requirements depend on the number and status of employees, including whether such employees are full time (FT), part time (PT), hourly, salaried, seasonal, and the like, these determinations change over time. Thus, it is necessary to provide a system that may receive the data at regular intervals, in order to update and modify, as necessary, the status and health care plans offered to an employer's workforce. The system is programmed to notify the employer regarding crucial deadlines, changes in status of employees that may trigger health care plan eligibility or ineligibility if an employee moves to part-time hours, and alert the employer when steps must be taken for the employer to maintain compliance with such laws, rules and regulations.

It should be understood that the terms “employer,” “corporation” and “company” may be used interchangeably herein to mean an entity that employs a workforce. Additionally, the following acronyms may be used in place of certain terms:

ALE: Applicable Large Employer (with 50+ FTEs)

FTE: Full-Time Equivalents—includes Full-Time employees as well as portion of Part-Time employee hours worked.

FT EE: Full-Time Employees working 30+ hours a week or 130+ hours a month

A/MV: References Affordable and Minimum Value healthcare which is required in order for a health plan to be considered EESP

A: Affordability meaning employee's portion of coverage costs no more than 9.5% of employee's taxable wages (listed in Box 1 of W-2)

MV: Minimum Value meaning employer's cost of the health plan is at least 60% of the total cost.

EESP: Eligible Employer Sponsored Plan—meets minimum standards to be an eligible health plan.

MP: Measurement Period of no less than 3 months and no more than 12 months provided as a voluntary safe harbor for employers to determine if variable hour and/or seasonal employees should be offered coverage prospectively.

SP: Stability Period of no less than 6 months and at least equal to MP during which time persons determined to be eligible for coverage during MP are offered coverage regardless of number of hours worked.

AP: Administrative Period which is effectively the waiting period during which employer can determine who is eligible for coverage and enroll (or at least offer) eligible employees coverage. Is the time period between MP and SP.

In one embodiment, the web-based software may be provided and maintained by a service provider, and client companies may pay a fee or subscription for access to the system via the internet. Periodically, the client companies provide data to the system, either automatically or manually, and the system runs its calculations and notifies the client company of changes in status of employees, deadlines, etc. Of course, the system must be updated to reflect changes in the law as they occur. The system allows a client company to use data that they already collect, so that they are not required to implement a whole new compliance system internally, and reduces the likelihood that they must hire additional compliance staff in order to avoid costly government-imposed penalties.

Implementation:

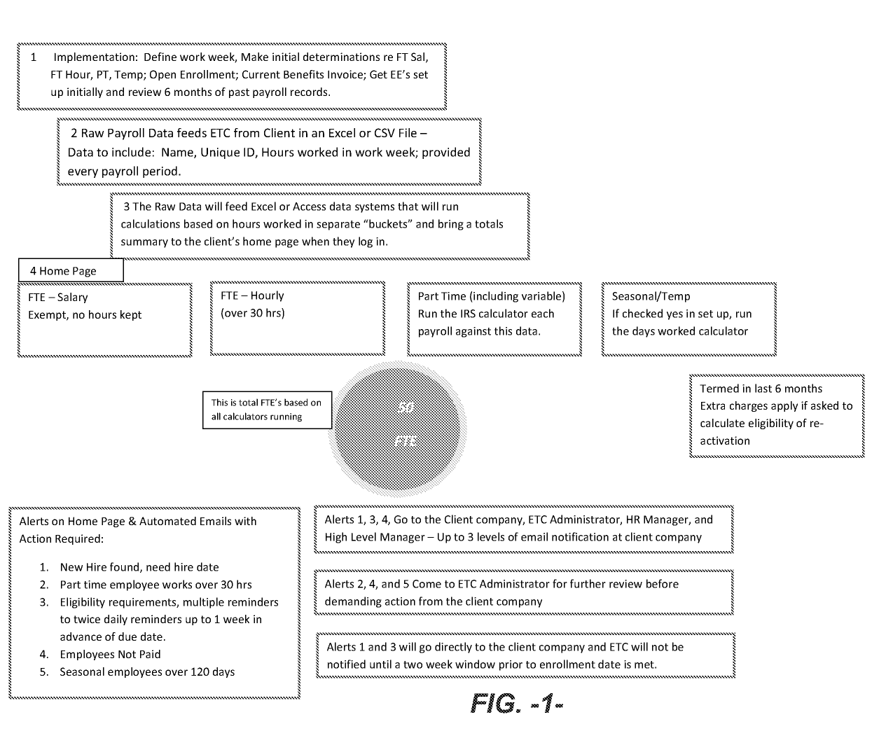

FIG. 1 shows a graphical representation of one embodiment of the system. The employer must define the “regular workweek” which is a 7 day 24 hour continuous period, as defined by the U.S. Department of Labor. The employer provides the most current employee benefits invoice so that all employees persons listed on invoice are tagged by the system as covered employees. From 6 months of past payroll records, the software identifies employees as Full-Time Salary, Full-Time Hourly, Part-Time, or Seasonal. The system also identifies any persons who may be eligible for the tax credits/subsidies for lack of affordable coverage.

On an ongoing basis, the system receives the employer's objective raw data from current payroll or time and attendance systems (preferably through Excel or CSV files). The data includes: employee name, unique identifier, status of hourly or salary, number of hours worked in a week, number of days worked in a workweek, and pay for these hours. In one embodiment, the client company simply sends an email message with an attachment to the service provider, wherein the email attachment may be an electronic spreadsheet including the raw payroll data. The service provider may then import the required data from the spreadsheet into the software, so that the system may run the calculations and generate the output (alert notifications and reports, if desired).

From this initial and ongoing data, either the software or a user places employees into separate categories for tracking purposes. Those categories include:
a. FT Salary employees—automatically eligible and to be offered/enrolled in benefits no later than the 91^{st} day after employment begins;
b. FT hourly employees—as long as working 30+ hours, automatically eligible and to be offered/enrolled in benefits no later than the 91^{st} day after employment begins;
c. Part-Time employees—not eligible for benefits if average less than 30 hours a week but make up part of the total number of FTEs to determine if the employer is subject to the regulations; and
d. If employer identifies certain employees as Seasonal (Temporary) employees, these persons are not eligible for benefits unless these persons work more than 120 days in a calendar year (which does not have to be continuous);
e. Employees missing from payroll—either terminated or on unpaid leave (these persons remain on service provider's system for 6 months because these persons may be eligible for benefits and their previous employment time is counted towards eligibility if they rehire within 6 months).

After importing the raw payroll data into the system, the system confirms that the FTs and PTs are actually classified correctly based on payroll on a monthly basis. The system also identifies employees who are not currently receiving benefits, but who are eligible, and repeatedly alerts the client company until the client company takes action and confirms that the employee was offered benefits and enrolled or declined enrollment in order to ensure that the employer (client company) avoids ACA penalties for non-compliance. The system also compares monthly “adjusted gross” income of each employee to the cost of premiums charged for employee only coverage for the base health plan in order to ensure coverage is considered “affordable” under the legislation, and identifies employees for whom coverage is not considered “affordable,” which may expose the client company to such penalties. An employer can offer different levels of plans and employees can pick the plan they desire, but the 9.5% calculation only applies to the least expensive (base) plan for employee only coverage regardless of what plan the employee chooses. The system further tracks those eligible employees who declined to receive coverage. In one embodiment, if an employee declines coverage, then that employee is required to sign a document stating that he or she has declined the coverage, and the document is scanned or otherwise entered into the System and linked with that specific employee within the system, in order to maintain the record showing that the employee was offered and declined the coverage. Additionally, the system further tracks when such benefits must be offered again to an employee who previously declined coverage.

After these initial steps have been taken, the system generates and communicates various alerts to the client company, prompting the client company to take some action in response thereto. In one embodiment, certain critical alerts that are sent to the client company require an electronic acknowledgement that they have received the alert, and these alerts may be categorized as an “action item” that requires the client company to take the appropriate action. These critical alerts may be generated repeatedly, over the course of regular intervals (once a week, for instance), until the client company has 1) acknowledged receipt of the alert, and/or 2) electronically indicated that action has been taken in response to the alert.

Alerts

The system is designed to generate “alerts” or notifications to the client company, in order to prompt the client company to take some action (or at least to be aware that some action is required) to avoid penalties for non-compliance. Such alerts will include the following types of notifications:
1. ID new hire (first payroll the person pops up) and obtain actual start date from employer in order to track timing for eligibility for benefits;
2. Alert employer when a PT classified person is working 30+ hrs on a weekly basis and request information as to whether the person's status changed (promotion to FT in which case benefit eligibility within 90 days) or still PT with more hours for a limited time in which case the System tracks the hours worked and alerts the employer if the person becomeseligible for benefits due to increase in hours worked and when the benefits should be offered and enrollment should take place;
3. Alert employer when FT employee's hours fall below Full Time (30) and request information as to whether the employee's status changed from FT to PT thusly causing the need for a COBRA notice to be sent for continuation of benefits purposes;
4. Eligibility Reminders to employer designated representatives (including insurance broker and/or enrollment company) advising of employee's eligibility for benefits and need for action (multiple reminders and action required of employer). If the employer does not confirm that action has been taken as a result of the alert (or series of alerts) that have been sent, then the system notifies personnel from the service provider, who then contacts client company (preferably starting on the 70^{th} day of employment of the specific employee at issue) to ensure that action is taken to remain in compliance;
5. Advisory of employees who are not on payroll for whatever reason—and reminders regarding need to offer COBRA if terminated or if on unpaid leave, reminder regarding employee's required portion of premium payment and request client company to provide information as to the reason that employee is not on payroll in order to move the employee into the correct category and continue tracking If the employee is on unpaid leave, then he or she is still eligible for benefits. If the employee is terminated, then that employee is moved to the inactive category for six (6) months because eligibility for benefits continues if the employee returns within six (6) months;
6. Alert regarding Seasonal Employees and 120 days of work coming up beginning on the 90^{th} day of employment and every week thereafter—if employee works more than 120 days, then that employee must be offered and enrolled in benefits (or have declined in writing) by the 121^{st} day of employment.
7. Alert regarding eligibility for or lack thereof for Variable Hour and Seasonal Employees if employer chooses to implement the MP/SP Safe Harbor.

Additionally, the System may generate, either automatically or at a Client Company's request, periodic reports of various types. These employer-specific reports are communicated to the client company or employer, either via the website, or through other means, such as email or paper copies sent via regular mail. It is contemplated that the software may generate any number of the following reports on a regular basis automatically: 1) Monthly reports with total workforce with breakdowns of FT, PT, Seasonal; 2) Identification of persons on coverage and who declined coverage; and 3) Employee Income compared to employee cost of coverage (to identify potential 9.5% violations).

### Measurement Period (MP) and Stability Period (SP) Safe Harbor

IRS has offered ALEs a safe harbor for Variable Hour and Seasonal Employees only. If an employee is hired and the Employer cannot reasonably determine if the employee will be working full time or part time or if the employer expects the employee to work seasonally only, the employer may place the employee in a state of suspension. As well, for on-going employees, if it cannot be determined if these employees are going to work FT status, they may be placed in this category as well.

Employer defines a MP for all like employees of between 3 months and 12 months, during which time these persons are not eligible for coverage. If, at the end of the MP, the employee worked on average at least 30 hours a week (130 hrs a month), that person is eligible for coverage during the SP. SP can be no less than 6 months in length and must be at least the same length of time as MP and no more than one month longer than the MP. If an employee is determined to be eligible for coverage during the SP and is still employed, the number of hours worked during this period are ignored and eligibility during the SP is guaranteed. Finally, in order to determine eligibility or lack thereof, there is an Administrative Period of up to 3 months between MP and SP to identify those entitled to coverage, offer coverage and enroll eligible employees in coverage for start of SP.

### EXAMPLES

1. (On-Going Employees) Employee A and Employee B have been employed for several years continuously. Employee A was employed an average of 30 hours per week during MP from Oct. 15, 2015 through Oct. 14, 2016. Employee B worked less than average 30 hours per week between Oct. 15, 2015 and Oct. 14, 2016.

Conclusion: Employee A is considered eligible for benefits for the SP (Jan. 1, 2017 through Dec. 31, 2017). Employee A also maintained eligibility between October 14 and January 1 (AP).

Employee B is still eligible and on benefits thru Dec. 31, 2016 (AP) but is not eligible for benefits from Jan. 1, 2017 through Dec. 31, 2017, the SP.
2. (New Hires) Employer A uses a 6 mo Initial MP beginning on Employee C's start date of May 10, 2014 and runs through Nov. 9, 2014 during which time Employee C works an average of 30 hours a week. Employer A offers coverage to Employee C for stability period running from Jan. 1, 2015 through Jun. 30, 2015 (because Employer A has an AP through the end of 2014 which does not exceed 90 days).

If employer chooses to implement the MP/SP Safe Harbor, the System tracks the employees subject to these periods and provides employer with alerts/notices regarding eligibility and need to offer coverage to the extent that such coverage is needed in order to ensure that employer is in compliance with the timing of the offer of benefits regulations.

### Recordkeeping:

Because an employee's eligibility for coverage and subsidies through the Exchange is based initially on Employee's application, the Employer must be prepared with accurate records to prove that the Employee was not entitled to subsidies (thereby subjecting Employer to penalties). How does employer do this with the System?
1. The System will track dates of offers of coverage and, if declined by an eligible employee, have documentation of declination;
2. The System will track actual time worked (or for which paid leave was provided) by employee on a weekly basis to show eligibility or lack thereof for coverage through employer;
3. The System will keep track of all eligible employees and those eligible who were inadvertently not offered coverage every month because if only 5% or 5 EEs eligible (whichever number is higher) were not offered coverage in a timely manner, Employer is not subject to the $2,000 per annum per eligible employee penalty. BUT employer has the burden of proof and the System will provide that proof to employer if needed.
4. The System will alert Employer of persons eligible and not offered coverage on a monthly basis so that, even if the Employer failed to offer coverage one month to more than 5% of the eligible employee population, the error will be rectified the following month and potential penalties limited as well.
5. Section 6056 Reporting to IRS and employee workforce:
   a. Effective 2015, ALEs are required to report certain information on employer-provided health care coverage provided Jan. 1, 2014 and thereafter to IRS and furnish related statements to employees.
   b. Information will be used by IRS to verify Employer Sponsored Coverage and to administer the shared employer responsibility provisions (ie assess penalties) under sections 4980H(a) and (b).
   c. Information required:
      i. Name and EIN of ALE
      ii. Date of Return
      iii. Certify whether ALE offers all FT EEs (and their dependents) coverage under an EESP and, if so, certify
         1. Duration of waiting period
         2. Months during calendar year when coverage was available
         3. Monthly premium for lowest cost option (Affordability)
         4. Employer's share of total costs of benefits provided (Minimum Value)
   d. Report number of FT EEs for each month of the calendar year
   e. Report, for each FT EE name, address, TIN and months (if any) during which FT EE (dependents) were covered under the EESP.

The system may provide the data and certification (c.iii) that ALE offers all Full-Time employees (and their dependents) coverage under an EESP, and may certify the duration of the waiting period, the calendar months when coverage was available, and the monthly premium for the lowest cost option. This information is produced and certified for Employer to incorporate and certify in the Form 6056. The system may also provide Employer with the information required under sections d and e, or specifically, it may report the number of Full-Time employees for each month of the calendar year, and may report, for each Full-Time employee, that employee's name, address, TIN and months (if any) during which the Full-Time employee (including dependents) were covered under the EESP.

It is contemplated that the system may be implemented as a web-based service, or as stand-alone software, so that a user may simply load and use the software on an individual computer. For the web-based version, the software is housed and maintained by a service provider, and client companies may pay a fee or subscription in order to use the system. Preferably, the client company sends spreadsheets at the end of each pay period with payroll and/or employee time and attendance data, and that data is imported into the system, either automatically or manually. After the system has run its calculations and performed the tracking discussed hereinabove, it generates alerts and notifications back to the client company, in order to prompt the client company to take action in order to remain in compliance with health care laws, and to avoid costly penalties. These alerts may be sent until acknowledged by the client company, and the system may further require the client company to provide an electronic notification that the action has been taken. If these alerts are ignored by the client company for a certain time period, in one embodiment, then the system notifies staff of the service provider, who contacts the client company directly in order to prompt appropriate action.

Thus, in summary, the software that embodies the system set forth herein is adapted to receive, either manually or automatically, information from an employer that is already kept in the course of doing business, including payroll data and/or time and attendance data, and tracks employees and their related data in various categories, including Full-Time salary employees, Full-Time hourly employees, Part-Time employees, Seasonal employees and employees missing from payroll. The system is updated with this information on a regular basis, and ensures that employees are offered benefits that are affordable in a timely manner under the law. Additionally, the system makes sure that the employees are properly categorized, and notifies the user and/or client company of actions that must be taken to become or remain in compliance with the laws.

Such a system streamlines the compliance process in a cost and time-efficient manner, potentially obviating the need to hire additional compliance staff, and minimizes the likelihood that the employer may be exposed to costly penalties for non-compliance.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, and modifications may be created if and when legal requirements relating to Healthcare Reform Affordable Care Act change unless expressly stated otherwise. Thus, unless expressly stated otherwise, each feature disclosed is one example only of a generic series of equivalent or similar features.

What is claimed is:

1. A method for tracking a workforce and calculating eligibility of employees for health care benefits, said method comprising the steps of:
providing a computer and software programmed on said computer;
entering information into said software, said information including names of employees who form a workforce, and for each said employee, identifying whether said employee works on an hourly or salary basis, number of hours worked per week, number of days worked in a week, and amount of pay;
categorizing each employee within said software as either Full-Time salary, Full-Time hourly, Part-Time, seasonal, or employee missing from payroll;
using said software to identify employees who are not enrolled in a benefits plan but who are eligible for a benefits plan, and to identify when said employees are eligible for such benefits;
using said software to compare monthly income of each said employee to a cost of minimum benefit plan being offered to determine whether said benefits plan being offered complies with current legislation;
using said software to track which employees are currently enrolled in a benefits plan and which employees have declined to enroll in a benefits plan; and
using said software to generate an alert if additional action is required in order to comply with current legislation.

2. The method set forth in claim 1, wherein said alert is a notification to identify a new employee in order to obtain a start date of said employee's employment to track timing for said employee's eligibility to enroll in a benefits plan.

3. The method set forth in claim 1, wherein said alert is a notification that a Part-Time classified employee is working more than a maximum allowed number of hours for a Part-Time employee under current legislation, in order to determine whether said Part-Time employee is or may become eligible to enroll in a benefits plan.

4. The method set forth in claim 1, wherein said alert is a notification that an employee has become eligible for a benefits plan.

5. The method set forth in claim 4, wherein said alert further includes a notification of the date upon which said employee must be offered a benefits plan.

6. The method set forth in claim 1, wherein said alert is a notification that COBRA benefits plan must be offered to an employee.

7. The method set forth in claim 1, wherein said alert is a notification that an employee classified as Seasonal may be or has become eligible to become enrolled in a benefits plan.

8. The method set forth in claim 1, further including the step of using said software to generate a report that includes a breakdown of said workforce into Full-Time employees, Part-Time employees and seasonal employees.

9. The method set forth in claim 1, further including the step of using said software to generate a report that includes a list of employees who are enrolled in a benefits plan and a list of employees who declined coverage.

10. The method set forth in claim 1, further including the step of entering into said software an electronic representation of a document executed by an employee stating that the employee was offered and declined to become enrolled in a benefits plan.

11. The method set forth in claim 1, further including the step of using said software to generate a document certifying that an employer offers all Full-Time employees and dependents coverage under an employee benefit plan.

12. The method set forth in claim 11, wherein said document further includes a list of months during a calendar year when said benefit plan was available to said employees.

13. The method set forth in claim 11, wherein said document further includes an employer's share of total costs of benefits plans provided to employees.
